(19) United States
(12) Patent Application Publication
(10) Pub. No.: US 2015/0109082 A1
(43) Pub. Date: Apr. 23, 2015

(54) COIL COMPONENT AND MANUFACTURING METHOD THEREOF

(71) Applicant: SAMSUNG ELECTRO-MECHANICS CO., LTD., Suwon (KR)

(72) Inventors: Duck Jin AN, Suwon (KR); Jin An JUNG, Suwon (KR); Young Min LEE, Suwon (KR); Eun Hee YOON, Suwon (KR)

(73) Assignee: SAMSUNG ELECTRO-MECHANICS CO., LTD., Suwon (KR)

(21) Appl. No.: 14/147,829

(22) Filed: Jan. 6, 2014

(30) Foreign Application Priority Data
Oct. 23, 2013 (KR) 10-2013-0126668

(51) Int. Cl. H01F 27/06; H01F 41/06; H01F 30/06

(52) U.S. Cl. CPC H01F 27/06; H01F 30/06; H01F 41/06; H01F 2027/065
USPC 336/65; 29/605

(57) ABSTRACT

There is provided a coil component capable of significantly decreasing interference between coil components while implementing a plurality of coil components as a single component. The coil component according to an exemplary embodiment of the present disclosure may include: at least two drum cores; a plurality of coils wound around each of the respective drum cores; and a base interposed between the two drum cores.

### CROSS-REFERENCE TO RELATED APPLICATION

This application claims the benefit of Korean Patent Application No. 10-2013-0126668 filed on Oct. 23, 2013, with the Korean Intellectual Property Office, the disclosure of which is incorporated herein by reference.

### BACKGROUND

The present disclosure relates to a coil component and a manufacturing method thereof, and more particularly, to a coil component allowing for interference between coil components to be significantly decreasing while allowing for a plurality of coil components to be implemented as a single component.

A switching-mode power supply (SMPS) is generally used as a power supply device in electric and electronic devices such as display devices, printers, and the like.

Such an SMPS, a module type power supply converting commercially available electricity into a form appropriate for various electric and electronic devices such as computers, televisions (TVs), video cassette recorders (VCRs), switchboards, wireless communications devices, and the like, serves to control the switching at a frequency higher than a commercial frequency and alleviate impacts using semiconductor switching characteristics.

Recently, as the size of TVs has increased, high amounts of power have been required. To meet demand therefor, a plurality of coil components may be mounted in a SMPS for powering the lighting of a backlight of a large panel.

In the case of coil components mounted in a SMPS according to the related art, generally, one coil is included in one component.

However, as the size of the panel is increased, a plurality of coil components may be mounted in the SMPS, and accordingly, there may be a problem, in that a size of the SMPS may be increased. In addition, since the plurality of coil components should be mounted on a substrate, there may be disadvantages in that a production rate may be slow, and manufacturing costs may be high.

### Related Art Document

(Patent Document 1) Korean Patent Laid-open Publication No. 2009-0040798

### SUMMARY

An aspect of the present disclosure may provide a coil component allowing for a coil to be automatically wound, and a manufacturing method thereof.

An aspect of the present disclosure may also provide a coil component allowing for a coil to be wound in a state in which a core and a base thereof are assembled, and a manufacturing method thereof.

Further, an aspect of the present disclosure may also provide a coil component capable of being easily used in a relatively small electronic device, and a manufacturing method thereof.

In addition, an aspect of the present disclosure may also provide a coil component capable of significantly decreasing interference between coils even in the case that a plurality of coils are integrated within a single component, and a manufacturing method thereof.

According to an aspect of the present disclosure, a coil component may include: at least two drum cores; a plurality of coils wound around each of the respective drum cores; and a base interposed between the two drum cores.

The drum cores may be coupled to the base so that central axes thereof are disposed in a linear manner.

The drum core may include a body part around which the coil is wound and flange parts extended from both ends of the body part.

At least one flange part of the drum core may be attached to one surface of the base.

The base may include at least one core receiving groove into which the flange part of the drum core is insertedly coupled.

A plurality of external connection terminals may be coupled to a lower surface or a side of the base.

The base may include a terminal part protruding from the side thereof, and the external connection terminals may be coupled to the terminal part.

The drum core may be formed of manganese-zinc (Mn—Zn) ferrite.

An insulating layer formed of an insulating resin may be formed on an outer surface of the drum core.

According to another aspect of the present disclosure, a coil component may include: a base; and at least two coil parts coupled to both surfaces of the base, respectively.

Each of the coil parts may include: a drum core coupled to the base; and a coil wound around the drum core.

The two coil parts may be coupled to the base so that the central axes of each of the respective drum cores are disposed in a linear manner.

The two coil parts may be formed so that a coupling factor between the coil parts is 0.3 or less.

According to another aspect of the present disclosure, a manufacturing method of a coil component is provided, the manufacturing method including: coupling drum cores to both ends of a base, respectively; disposing the base having the drum core coupled thereto in an automatic winding device; and winding a coil around the drum core using the automatic winding device.

The winding of the coil around the drum core may include winding the coil while rotating an assembly in which the drum core and the base are coupled to each other.

The winding of the coil around the drum core may include rotating the assembly using a central axis of the drum core as a rotational axis.

The drum core may include a body part around which the coil is wound and flange parts extended from both ends of the body part, and the disposing of the base in the automatic winding device may include fixedly coupling the flange part of the drum core to the automatic winding device.

According to another aspect of the present disclosure, a coil component may be manufactured by the manufacturing method as described above.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view schematically illustrating a coil component according to an exemplary embodiment of the present disclosure;

FIG. 2 is a side view of the coil component shown in FIG. 1, and

FIG. 3 is an exploded perspective view of the coil component shown in FIG. 1;

FIG. 4 is a view for explaining a manufacturing method of a coil component according to an exemplary embodiment of the present disclosure;

FIG. 5 is a perspective view schematically illustrating a coil component according to another exemplary embodiment of the present disclosure; and

FIG. 6 is a side view of the coil component shown in FIG. 5.

### DETAILED DESCRIPTION

Exemplary embodiments of the present disclosure will now be described in detail with reference to the accompanying drawings.

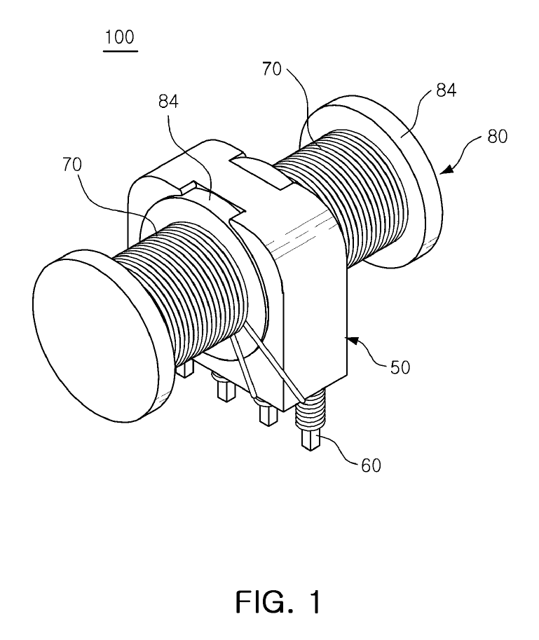

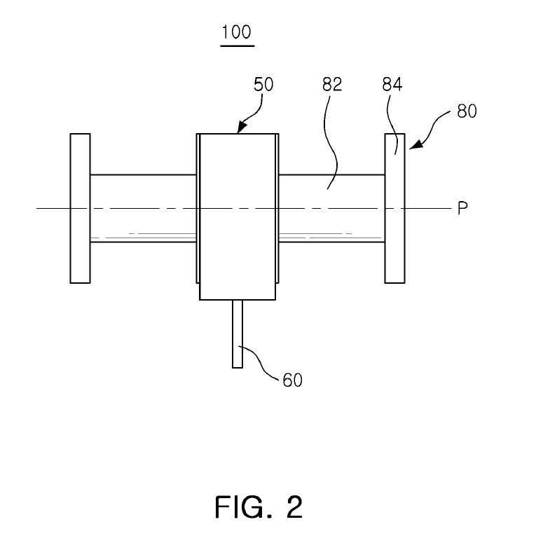

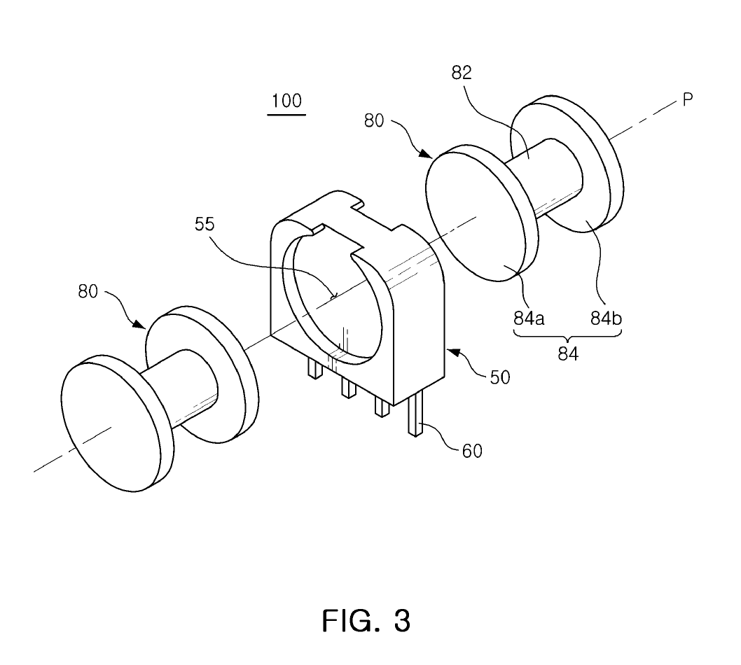

FIG. 1 is a perspective view schematically illustrating a coil component according to an exemplary embodiment of the present disclosure, FIG. 2 is aside view of the coil component shown in FIG. 1, and FIG. 3 is an exploded perspective view of the coil component shown in FIG. 1.

Referring to FIGS. 1 through 3, the coil component 100 according to an exemplary embodiment of the present disclosure may be a coil component used in a direct current (DC)/DC converter provided in a power supply, and may include drum cores 80, a coil 70, and a base 50.

The drum core 80, a portion around which a coil 70 is wound, to be described below, may include a cylindrical body part 82 and a flange part 84 extended from both ends of the body part 82.

The flange part 84 of the drum core 80 may be formed to have disk shapes. In addition, the flange parts 84 may be formed to have the same shape at both ends of the body part 82.

The flange part 84 may be divided into an inner flange part 84a and an outer flange part 84b according to a formation position thereof. The inner flange part 84a may refer to a portion bonded to the base 50, and the outer flange part 84b may refer to a portion exposed externally.

Meanwhile, in this exemplary embodiment, the case in which the flange parts 84a and 84b at both ends of the body part 82 have the same size as each other is described by way of example, but the present disclosure is not limited thereto. That is, if necessary, the flange part 84 may be variously applied. For example, the flange part 84 formed at any one end may be larger than that at the other end.

For example, a size of the inner flange part 84a coupled to the base 50 may be formed so as to be relatively smaller than that of the outer flange part 84b. In this case, since a size of the base 50 may be decreased so as to correspond to the size of the inner flange part 84a, the overall size of the coil component 100 may be decreased.

In addition, in this exemplary embodiment of the present disclosure, the case in which all of the flange parts 84 are formed to be circular in shape is described by way of example. However, a configuration of the present disclosure is not limited thereto, and the flange part 84 may be formed to have various shapes such as a polygonal shape, or the like, as needed.

The drum core 80 as described above may be formed of ferrite having higher permeability, lower loss, higher saturation magnetic flux density, stability, and lower production cost, as compared to other materials.

For example, the drum core 80 according to this exemplary embodiment may be formed of nickel (Ni)-based ferrite or manganese (Mn)-based ferrite. Particularly, in the case in which the coil component 100 according to this exemplary embodiment is used as a driving coil 70, when the drum core 80 is formed of the manganese-based ferrite, higher efficiency may be obtained.

More specifically, the drum core 80 may be formed of manganese-zinc (Mn—Zn) ferrite. In the case of forming the drum core 80 using the Mn-Zn ferrite, current capacity may be increased as compared to the case of using nickel-zinc (Ni—Zn) ferrite. Therefore, it is preferable that in the driving coil 70 using high current, Mn-Zn ferrite be used.

Meanwhile, in the case of forming the drum core 80 using the Mn—Zn ferrite, insulation resistance of the drum core 80 may be weakened. Therefore, in this case, an insulating layer (not shown) may be added to an outer surface of the drum core 80. Here, the insulating layer may be formed of an insulating resin such as an epoxy resin.

The coil component 100 according to this exemplary embodiment configured as described above may include two drum cores 80. The coil 70 is wound around each of the two drum cores 80 to operate as an independent coil part (that is, a coil component).

The coil 70 may be wound around the body part 82 of the drum core 80.

As the coil 70, a single strand of wire may be used, or a Ritz wire formed by twisting several strands of wire together may be used. Lead wires at both ends of the coil 70 may be electrically and physically connected to an external connection terminal 60 provided in a base 50 to be described below.

In addition, in the coil component 100 according to this exemplary embodiment, the coils 70 wound around two drum cores 80 may be wound in different directions from each other (that is, opposing directions), respectively. For example, in the case in which the coil 70 is wound around one drum core 80 in a clockwise direction, the coil 70 maybe wound around the other drum core 80 in a counter-clockwise direction. However, the present disclosure is not limited thereto, and if necessary, winding of the coil may be variously applied. For example, the coils may be wound in opposing directions as described above, or two coils 70 may be wound in the same direction as each other.

The inner flange part 84a of the drum core 80 may be bonded to the base 50. Therefore, the base 50 may have a structure in which the drum core 80 may be firmly fixedly adhered thereto and at the same time, the body part 82 of the drum core 80 may be exposed for automatic winding.

More specifically, the base 50 according to this exemplary embodiment may have a body having a flat plate shape and may include a core receiving groove 55 and the external connection terminal 60.

The core receiving grooves 55 may be formed in both flat surfaces of the base 50, respectively. The core receiving groove 55 is a portion in which the drum core 80 is received and coupled. Therefore, the core receiving groove 55 may be formed in a groove shape into which the flange part 84 of the drum core 80 may be inserted.

In detail, the core receiving groove 55 may be formed in a shape of the flange part 84, that is, a circular groove. In addition, the core receiving groove 55 may have a depth equal to or shallower than a thickness of the flange part 84.

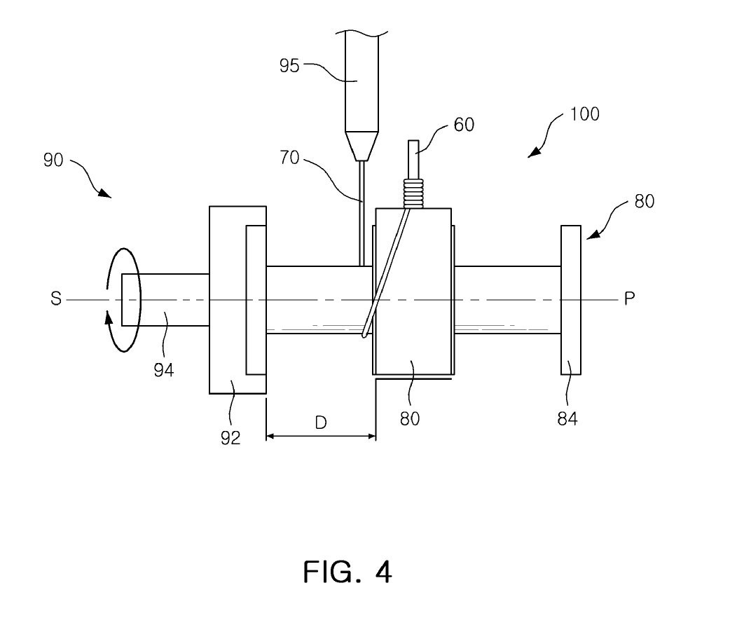

In the core component 100 according to this exemplary embodiment, the coil 70 may be automatically wound around the drum core 80 using an automatic winding device (90 of FIG. 4). Therefore, the body part 82 of the drum core 80, a region around which the coil 70 is wound, needs to be completely exposed externally.

To this end, in the coil component 100 according to this exemplary embodiment, when the drum core 80 is coupled to the core receiving groove 55, the drum core 80 is inserted so that the body part 82 of the drum core 80 is completely exposed externally. That is, an inner surface of the inner flange part 84a may be coupled to an outer surface of the base 50 so as to be disposed on the same plane as the outer surface of the base 50 or protrude from the outer surface of the base 50.

In addition, two core receiving grooves 55 formed in both surfaces of the base 50 may be formed so as to be disposed in a linear manner. Therefore, when the drum core 80 is coupled to each of the two core receiving grooves 55, the two drum cores 80 may be disposed so that central axes P of the body parts 82 are formed in a linear manner.

Here, the central axis P of the drum core 80 may be used as a rotational axis of the coil component 100 at the time of winding the coil 70.

In addition, the drum core 80 may be firmly fixedly bonded to the base 50 by an adhesive, or the like.

The external connection terminal 60 may be coupled to the base 50 in a shape in which the external connection terminal 60 protrudes outwardly from the base 50. In this exemplary embodiment, the case in which the external connection terminal 60 protrudes downwardly from the base 50 is described by way of example.

However, the present disclosure is not limited thereto. That is, the external connection terminal 60 may be coupled so as to protrude toward a side of the base 50 rather than a lower portion thereof and may be formed in a shape in which the external connection terminal 60 is partially bent.

In addition, as shown in FIG. 3, the base 50 according to this exemplary embodiment may include four external connection terminals 60. The reason is that the coil component 100 according to this exemplary embodiment is configured to include two coils 70. Therefore, the coil component 100 according to an exemplary embodiment of the present disclosure is not limited thereto, and the number of external connection terminals 60 included in the coil component 100 may correspond to the number of coils 70 included therein.

The base 50 as described above may be easily manufactured by injection molding, but is not limited thereto, and may be manufactured by various methods such as a press processing method. In addition, it is preferable that the base 50 according to this exemplary embodiment may be formed of an insulating resin material and a material having high heat resistance and high voltage resistance.

As a material forming the base 50, polyphenylenesulfide (PPS), liquid crystal polyester (LCP), polybutyleneterephthalate (PBT), polyethyleneterephthalate (PET), phenolic resin, and the like, may be used.

In the coil component 100 according to this exemplary embodiment configured as described above, two coil parts operating independently of each other may be implemented in a single coil component 100. In the case of implementing a plurality of independent coil parts in a single component, interference between magnetic fluxes generated in respective coil parts needs to be minimized.

That is, it is preferable that the magnetic fluxes generated in two coil parts are formed so that a coupling factor K therebetween is close to ‘0’, and when the magnetic fluxes are formed so that the coupling factor is at least 0.3 or less, a deviation of output current may be decreased.

To this end, the coil component 100 according to this exemplary embodiment is configured to have a structure in which two drum cores 80 are coupled to one base 50 but the base 50 is interposed between the two drum cores 80, and the coupling factor between the coil parts may be maintained at 0.3 or less by this structure.

Therefore, each of the respective drum cores 80 having the coil 70 wound therearound may perform a function as an independent coil part.

Meanwhile, the coil component 100 according to this exemplary embodiment is configured so as to be suitable for an automated manufacturing method. That is, in the coil component 100 according to this exemplary embodiment, the coil 70 may be wound around the drum core 80 using a separate automatic winding device in a state in which all of the drum cores 80 and the base 50 are coupled to each other.

Hereinafter, a manufacturing method of a coil component according to the present disclosure will be described. Configurations of the above-mentioned coil component will also be clearly described by the following description.

FIG. 4 is a view for explaining a manufacturing method of a coil component according to an exemplary embodiment of the present disclosure.

Referring to FIGS. 3 and 4, in the a manufacturing method of a coil component according to this exemplary embodiment, first, a step of coupling the drum core 80 to the base 50 may be performed.

In this case, if necessary, an adhesive may be interposed at a portion at which the base 50 contacts the drum core 80. That is, before the drum core 80 is coupled thereto, the adhesive may be applied into the core receiving groove 55. However, the present disclosure is not limited thereto, and in the case in which coupling strength between the core 80 and the base 50 is sufficient, the adhesive maybe omitted in this step.

When the drum core 80 and the base 50 are coupled to each other, subsequently, a step of winding the coil 70 around the drum core 80 may be performed. This step may be performed by the separate automatic winding device 90.

As shown in FIG. 4, firstly, an assembly in which the drum core 80 and the base 50 are coupled to each other may be disposed in the automatic winding device 90. In this case, a rotational axis S of the automatic winding device 90 and a rotational axis P of the above-mentioned assembly may be disposed in a linear manner. Here, the rotational axis P of the assembly may be the central axis P of the body part 82 of the drum core 80 as described above.

Further, a flange part 84 of any one of two drum cores 80 of the assembly may be fixedly coupled to a coupling part 92 of the automatic winding device 90. In this case, the assembly is coupled so that the coupling part 92 of the automatic winding device 90 does not protrude toward the body part 82.

Therefore, while the assembly is coupled to the coupling part 92 of the automatic winding device 90, the body part 82 of the drum core 80 is maintained in a state in which the overall body part 82 is exposed externally.

Then, after one end of the coil 70 is connected to the external connection terminal 60, the coil 70 may be wound around the body part 82 of the drum core 80 while the assembly is rotated. Therefore, the coil 70 is wound on an outer peripheral surface of the body part 82 while being inserted into a space between the flange parts 84 of the drum core 80.

Here, the winding of the coil 70 may be performed by rotating a rotating shaft 94 of the automatic winding device 90. In addition, a nozzle 95 of the automatic winding device 90 may continuously provide the coil 70 from the exterior of the body part 82 while reciprocating within a length range D of the body part 82.

Meanwhile, the winding of the coil 70 may be performed in a manner in which one drum core 80 is completely wound with the coil and then the other drum core 80 is wound with the coil 70. However, in the case in which two nozzles 95 are provided in the automatic winding device 90, the coil 70 may be simultaneously wound around two drum cores 80. In this case, a manufacturing time may be significantly decreased.

When the winding of the coil 70 is completed, a distal end of the coil 70, that is, a lead wire is connected to the external connection terminal 60. Therefore, the coil component 100 according to this exemplary embodiment shown in FIG. 1 may be completed.

Thereafter, if necessary, a step of bonding the external connection terminal 60 and the lead wire of the coil 70 to each other using a molten solder, or the like, or a step of impregnating the coil component 100 in a solution filled with an insulating resin such as varnish, or the like, to fixedly bond the coil 70, the drum core 80, and base 50, to each other using the insulating resin may be further performed.

In the manufacturing method of a coil component according to this exemplary embodiment configured as described above, the coil 70 may be wound in a state in which the drum core 80 and the base 50 are coupled to each other. Therefore, the coil component 100 may be manufactured only using a process of assembling the drum core 80 and the base 50 and a process winding the coil 70 around the drum core 80 to connect the coil to the external connection terminal 60.

Therefore, there is an advantage in that the coil component may be easily manufactured as compared to a method of first winding the coil 70 around the drum core 80, fixing the drum core 80 to the base 50, and then connecting the coil 70 and the external connection terminal 60.

In addition, in the coil component 100 according to this exemplary embodiment, the central axes P of the drum cores 80 may be disposed so as to be formed in a linear manner. Therefore, since the coil 70 may be automatically wound around the drum core 80 using the automatic winding device 90, time consumed for the winding of the coil 70 may be decreased, such that the manufacturing time thereof may be decreased.

Further, in the coil component 100 according to this exemplary embodiment, two coil parts may be implemented as the single component. Therefore, as compared to the case according to the related art in which two coil parts are configured as separate components, respectively, and mounted, a space (or an area) of a substrate on which the coil component is mounted and the manufacturing cost may be decreased.

In addition, in the coil component 100 according to this exemplary embodiment, even in the case that two coil parts are integrated in the single component, since the coupling factor in the core is ‘0.3’ or less, the coil component 100 may obtain the same efficiency as that in the case in which two coil parts are configured as separate components, respectively.

Meanwhile, the present disclosure is not limited to the above-mentioned embodiment but may be variously applied.

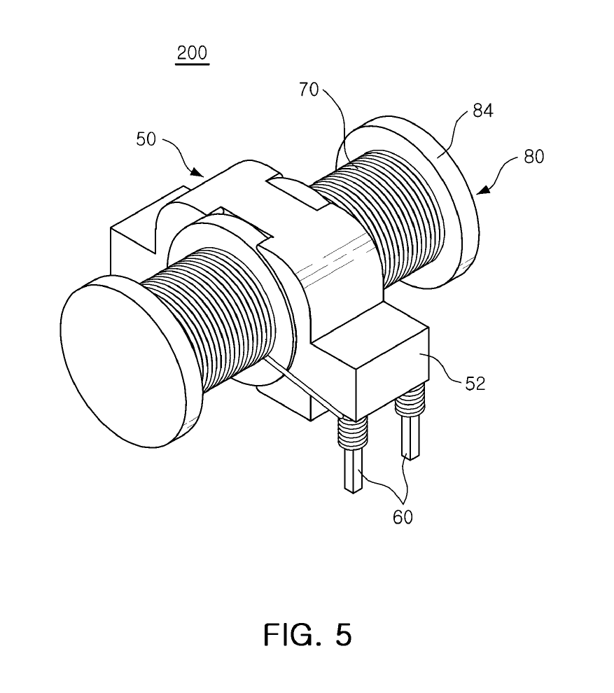

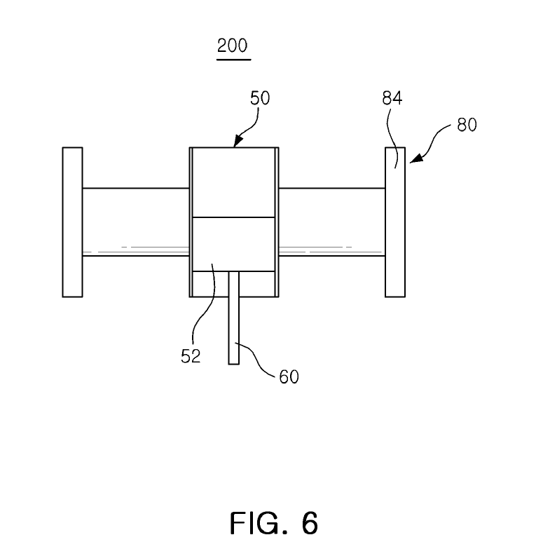

FIG. 5 is a perspective view schematically illustrating a coil component according to another exemplary embodiment of the present disclosure, and FIG. 6 is a side view of the coil component shown in FIG. 5. Here, in FIG. 6, a coil is omitted.

The coil component 200 according to this exemplary embodiment has a structure similar to that of the coil component (100 of FIG. 1) according to the above-mentioned exemplary embodiment except for a structure of a base 50. Accordingly, a detailed description of the same components will be omitted, and the structure of the base 50 will mainly be described in detail. In addition, the same reference numerals will be used to describe the same components as those of the above-mentioned embodiment.

Referring to FIGS. 5 and 6, the coil component 200 according to this exemplary embodiment may include a coil 70, drum cores 80, and a base 50, similarly to the above-mentioned embodiment.

In the base 50 according to this exemplary embodiment, an external connection terminal 60 is not coupled to a lower portion of the base 50 but may be coupled to a terminal part 52 protruding from one side of the base 50.

In addition, the terminal part 52 may protrude outwardly from the side of the base 50. More specifically, the terminal part 52 may protrude in a direction perpendicular to a central axis of the drum core 80.

As the separate terminal part 52 is provided in the base 50, a thickness of the base 50 according to this exemplary embodiment may be significantly decreased. That is, the base 50 according to this exemplary embodiment may be formed so as to have a thickness equal to a diameter of a flange part 84 of the drum core 80. Therefore, a height of the coil component 200 may be significantly decreased.

Meanwhile, the coil component according to the present disclosure and the manufacturing method thereof described above are not limited to the above-mentioned embodiments but may be variously applied.

Further, although the coil component used in the DC/DC converter applied to a power supply is described in this exemplary embodiment, the coil component is not limited thereto, but the coil component may be widely applied in various electronic components and electronic devices as long as it uses a coil and a core.

As set forth above, in the coil component according to exemplary embodiments of the present disclosure, two coil parts are configured in a single component. Therefore, as compared to the case according to the related art in which two coil parts are configured as separate components, respectively, and mounted, a space (or an area) of a substrate on which the coil component is mounted may be decreased in addition to manufacturing costs.

In addition, in the coil component according to this exemplary embodiment, even in the case that two coil parts are integrated in the single component, since the coupling factor in the core is ‘0.3’ or less, the coil component may obtain the same degree of efficiency as that in the case in which two coil parts are configured as separate components, respectively.

In addition, in the manufacturing method of a coil component according to the present disclosure, the coil may be wound in the state in which the drum core and the base are coupled to each other. Therefore, the coil component may be manufactured only using the process of fixing the drum core and the base to each other and the process of winding the coil around the drum core to connect the coil to the external connection terminal.

Therefore, there is an advantage in that the coil component may be easily manufactured, as compared to the method of firstly winding the coil around the drum core, assembling the drum core to the base, and then connecting the coil and the external connection terminal.

In addition, in the coil component according to the present disclosure, the central axes of the drum cores may be disposed so as to be formed in a linear manner. Therefore, since the coil may be automatically wound around the drum core using the automatic winding device, the time consumed for winding of the coil may be decreased, thereby decreasing the manufacturing time required therefor.

While exemplary embodiments have been shown and described above, it will be apparent to those skilled in the art that modifications and variations could be made without departing from the spirit and scope of the present disclosure as defined by the appended claims.

What is claimed is:

1. A coil component comprising:
at least two drum cores;
a plurality of coils wound around each of the respective drum cores; and
a base interposed between the two drum cores.

2. The coil component of claim 1, wherein the drum cores are coupled to the base so that central axes thereof are disposed in a linear manner.

3. The coil component of claim 1, wherein the drum core includes a body part around which the coil is wound and flange parts extended from both ends of the body part.

4. The coil component of claim 3, wherein at least one flange part of the drum core is attached to one surface of the base.

5. The coil component of claim 3, wherein the base includes at least one core receiving groove into which the flange part of the drum core is insertedly coupled.

6. The coil component of claim 1, wherein a plurality of external connection terminals are coupled to a lower surface or a side of the base.

7. The coil component of claim 6, wherein the base includes a terminal part protruding from the side thereof, and the external connection terminals are coupled to the terminal part.

8. The coil component of claim 1, wherein the drum core is formed of manganese-zinc (Mn—Zn) ferrite.

9. The coil component of claim 1, wherein an insulating layer formed of an insulating resin is formed on an outer surface of the drum core.

10. A coil component comprising:
a base; and
at least two coil parts coupled to both surfaces of the base, respectively.

11. The coil component of claim 10, wherein each of the coil parts includes:
a drum core coupled to the base; and
a coil wound around the drum core.

12. The coil component of claim 11, wherein the two coil parts are coupled to the base so that the central axes of each of the respective drum cores are disposed in a linear manner.

13. The coil component of claim 10, wherein the two coil parts are formed so that a coupling factor between the coil parts is 0.3 or less.

14. A manufacturing method of a coil component, the manufacturing method comprising:
coupling drum cores to both ends of a base, respectively;
disposing the base having the drum core coupled thereto in an automatic winding device; and
winding a coil around the drum core using the automatic winding device.

15. The manufacturing method of claim 14, wherein the winding of the coil around the drum core includes winding the coil while rotating an assembly in which the drum core and the base are coupled to each other.

16. The manufacturing method of claim 15, wherein the winding of the coil around the drum core includes rotating the assembly using a central axis of the drum core as a rotational axis.

17. The manufacturing method of claim 14, wherein the drum core includes a body part around which the coil is wound and flange parts extended from both ends of the body part, and
the disposing of the base in the automatic winding device includes fixedly coupling the flange part of the drum core to the automatic winding device.

18. A coil component manufactured by the manufacturing method of claim 14.
